(19) United States
(12) Patent Application Publication
(10) Pub. No.: US 2026/0309252 A1
(43) Pub. Date: Oct. 8, 2026

(54) SOLENOID PILOT VALVES FOR CRYOGENIC FLUID

(71) Applicant: Engineered Controls International, LLC, Elon, NC (US)

(72) Inventors: Guangbin Cao, Shanghai (CN); Xiang Tu, Liyang (CN)

(21) Appl. No.: 19/482,183

(22) PCT Filed: May 12, 2023
(86) PCT No.: PCT/CN2023/093906

§ 371 Date: Nov. 6, 2025

(51) Int. Cl. F16K 31/40; F16K 27/02; F16K 31/06

(52) U.S. Cl. CPC F16K 31/408; F16K 27/029; F16K 31/0655; F16K 2200/30; F16K 2200/402

(57) ABSTRACT

Solenoid pilot valves for cryogenic fluid are disclosed. An example valve includes a body defining an inlet side and an outlet side. The valve includes a coil assembly coupled to the body. The valve includes a poppet that is configured to translate between a closed position and an open position. The poppet defines a pilot hole that is configured to fluidly connect a chamber and the outlet side. The valve includes a plunger assembly positioned in the chamber. The plunger assembly includes a first plunger that is positioned such that the coil assembly is configured to cause the first plunger to translate. The plunger assembly includes a second plunger that is slidably coupled to the first plunger. The second plunger is configured to close the pilot hole in a second extended position and is configured to open the pilot hole in a partially retracted position and a second retracted position.

### TECHNICAL FIELD

This disclosure generally relates to solenoid valves and, more particularly, to solenoid pilots valves for use with a cryogenic fluid.

### BACKGROUND

Cryogenic control systems are configured to regulate fluid in a cryogenic cylinder or tank. A cryogenic cylinder generally houses a combination of liquid and gas at cryogenic temperatures (e.g., temperatures less than −150 degrees Celsius (−238 degrees Fahrenheit)). For instance, a cryogenic tank may house liquid (e.g., liquified natural gas, liquid hydrogen) along with gas (e.g., natural gas, hydrogen) in a head space above the liquid.

Oftentimes, a valve is used to regulate the flow of fluid from the cryogenic tank. In some instances, the cryogenic valve is a solenoid valve. A solenoid valve may include an electromagnetic coil that is mounted to a valve body. Some solenoid valves are normally-open valves in which the electromagnetic coil is energized to close the valve and deenergized to open the valve. Other solenoid valves are normally-closed valves in which the electromagnetic coil is energized to open the valve and deenergized to closed the valve. Some normally-closed valves for cryogenic fluid have difficulty forming a tight, sealed connection in the closed position, thereby unintentionally permitting the cryogenic fluid to flow from the cryogenic tank in the closed position.

### SUMMARY

An example solenoid pilot valve for cryogenic fluid disclosed herein includes a valve body. The valve body includes a first seat and defines a conduit that has an inlet side and an outlet side. The solenoid pilot valve includes a coil assembly coupled to the valve body. The solenoid pilot valve includes a poppet configured to translate between a closed position at which the poppet sealingly engages the first seat to fluidly disconnect the inlet side and the outlet side and an open position at which the poppet is disengaged from the first seat to fluidly connect the inlet side and the outlet side. The poppet, the valve body, and the coil assembly define a chamber. The poppet defines a pilot hole that is configured to fluidly connect the chamber and the outlet side. The poppet includes a second seat adjacent the pilot hole. The solenoid pilot valve includes a plunger assembly positioned in the chamber. The plunger assembly includes a first plunger positioned such that the coil assembly is configured to cause the first plunger to translate between a first extended position and a first retracted position. The plunger assembly includes a second plunger slidably coupled to the first plunger and extending toward the poppet. The second plunger is configured to translate between a second extended position, a partially retracted position, and a second retracted position. The second plunger is configured to sealingly engage the second seat to close the pilot hole in the second extended position and is configured to be disengaged from the second seat to open the pilot hole in the partially retracted position and the second retracted position.

### BRIEF DESCRIPTION OF THE DRAWINGS

FIG. 1 is a cross-sectional view of an example solenoid pilot valve for cryogenic fluid in accordance with the teachings herein.

FIG. 2 is a detail cross-sectional view of a plunger assembly and a poppet of the solenoid pilot valve of FIG. 1 in a closed state.

FIG. 3 is a detail cross-sectional view of the poppet of FIG. 2.

FIG. 4 illustrates a keyed surface of the poppet of FIG. 2 and a keyed gasket of the solenoid pilot valve of FIG. 1.

FIG. 5 is a detail cross-sectional view of an upper plunger of the plunger assembly shown in FIG. 2.

FIG. 6 is a detail cross-sectional view of a lower plunger of the plunger assembly shown in FIG. 2.

FIG. 7 is a perspective view of the plunger assembly of FIG. 2 with a body the lower plunger of FIG. 6 being depicted as transparent.

FIG. 8 is a detail cross-sectional view of the plunger assembly of FIG. 2 when the solenoid poppet valve of FIG. 1 is in a closed state or an intermediate state.

FIG. 9 is a detail cross-sectional view of the plunger assembly of FIG. 2 when the solenoid poppet valve of FIG. 1 is in an open state.

FIG. 10 is a cross-sectional view of the solenoid poppet valve of FIG. 1 in the closed state.

FIG. 11 is a cross-sectional view of the solenoid poppet valve of FIG. 1 in the intermediate state.

FIG. 12 is a cross-sectional view of the solenoid poppet valve of FIG. 1 in the open state.

FIG. 13 is a cross-sectional view of another example solenoid pilot valve for cryogenic fluid in accordance with the teachings herein.

FIG. 14 is a cross-sectional view of a plunger assembly and a poppet of the solenoid pilot valve of FIG. 13 in a closed state.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

Examples of a solenoid pilot valve disclosed herein include a valve body, a coil assembly coupled to the valve body, a poppet, and a plunger assembly with a pilot hole. The coil assembly is configured to energize and/or deenergize to cause movement of the plunger assembly, which, in turn, is configured to cause movement of the poppet. The poppet is configured to translate between a closed position to cryogenic fluid flow and an open position to permit the flow of cryogenic fluid. The solenoid pilot valve also includes one or more springs to bias the poppet toward the closed position.

The solenoid pilot valve is configured to form a tight, sealed connection in a closed state to prevent cryogenic fluid from unintentionally leaking through the solenoid pilot valve. For example, one spring of the solenoid pilot valve has a relatively great closing force and is arranged to ensure that the plunger assembly and the poppet form a sealed connection when the solenoid pilot valve transitions from an open state to a closed state. To transition to its open state, the solenoid pilot valve overcomes the closing force of that spring.

To facilitate the solenoid pilot valve in overcoming the closing force of the spring, the plunger assembly is a multi-plunger assembly that includes an upper plunger partially nested within a lower plunger. For example, the coil assembly pulls the upper plunger and the lower plunger upward together upon being energized. When the lower plunger is pulled upward, it disengages from a poppet seat of the poppet to fluidly connect an outlet-side of the valve body to a pressure chamber in which the plunger assembly is positioned. In turn, the pressure within the pressure chamber equalizes with that of the outlet-side pressure, which enables the lower plunger to slide upward relative to the upper plunger and the poppet to slide upward and disengage from a valve seat to open the solenoid pilot valve. Additionally, the stroke length of an upper plunger of the plunger assembly is relatively short to further facilitate the solenoid pilot valve in overcoming the closing force of the spring. For example, the stroke length is about 0.80 millimeters (0.031 inches) for a solenoid pilot valve for liquified natural gas (LNG) and is about 0.88 millimeters (0.035 inches) for a solenoid pilot valve for liquid hydrogen (LH2).

That is, examples of the solenoid pilot valve disclosed herein include a spring with a relatively great closing force to ensure that the plunger forms a tight, sealed connection with the valve seat in the closed position. The solenoid pilot valve includes a multi-plunger assembly and incorporates a relatively short stroke length of the upper plunger to enable the solenoid pilot valve to overcome the closing force of the spring and, in turn, transition to the open state.

Additionally, when the coil assembly becomes deenergized, the spring pushes the poppet and the upper and lower plungers of the plunger assembly downward with the relatively great closing force to ensure that (1) the poppet forms a tight seal with the valve seat and that (2) the lower plunger forms a tight seal with the poppet seat in the closed state. In examples disclosed herein, the poppet may also include a relatively small O-ring that is capable of forming a tight seal with the valve seat at cryogenic temperatures without deforming. Additionally or alternatively, the poppet seat may be at least partially formed of plastic to ensure a tight seal between the lower plunger and the poppet seat in the closed state. Further, in some such examples, the poppet seat is an insert that may be removed and replaced after extended use.

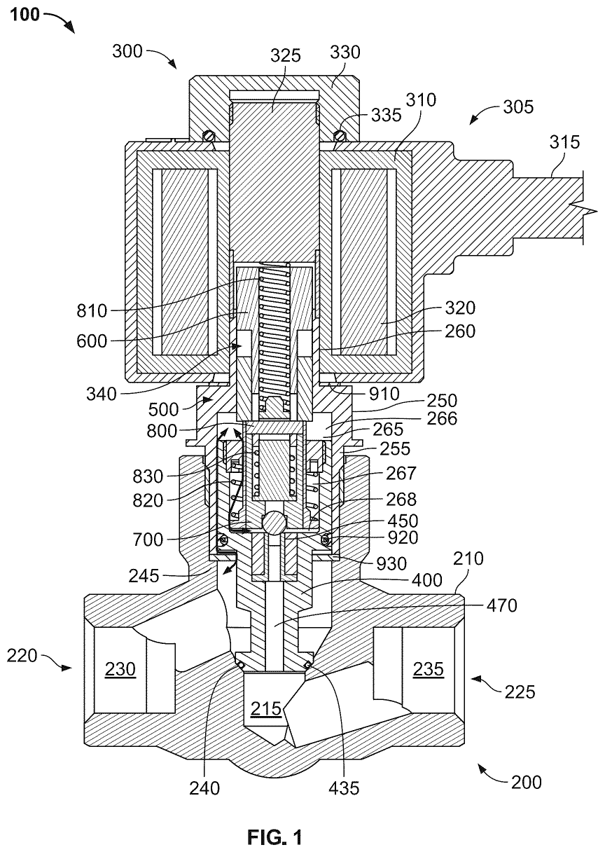

Turning to the figures, FIG. 1 illustrates an example embodiment of solenoid pilot valve 100 (also referred to as “valve” and “pilot valve”). Valve 100 is configured to control the flow of cryogenic fluid, such as liquified natural gas (LNG). Valve 100 of the illustrated example includes body 200 (also referred to as “valve body”), coil assembly 300, poppet 400, and plunger assembly 500.

Body 200 of valve 100 includes main body 210, which defines conduit 215, inlet port 220, and outlet port 225. Conduit 215 extends between inlet port 220 and outlet port 225 such that outlet port 225 is in fluid communication with inlet port 220 to enable cryogenic fluid, such as LNG, from inlet port 220 and to outlet port 225. In some examples, inlet port 220 and outlet port 225 are threaded, standard-sized hydraulic ports configured to receive fluid fittings. Conduit 215 includes inlet side 230 adjacent to inlet port 220 and outlet side 235 adjacent to outlet port 225. Inlet side 230 and outlet side 235 are separated by valve seat 240. Main body 210 includes valve seat 240 (also referred to as “first seat” or “first valve seat”) that is positioned along conduit 215 between inlet port 220 and outlet port 225. In the illustrated example, valve seat 240 is angled. As disclosed below in greater detail, valve seat 240 is configured to be sealingly engaged with and disengaged from poppet 400. When valve seat 240 sealingly receives to poppet 400, outlet port 225 is fluidly disconnected from inlet port 220 to prevent the cryogenic fluid from flowing through conduit 215. When poppet 400 is disengaged from valve seat 240, outlet port 225 is fluidly connected to inlet port 220 to permit the cryogenic fluid to flow through conduit 215.

Body 200 also includes cartridge 250, which is coupled to and extends between main body 210 and coil assembly 300. For example, cartridge 250 is threadably coupled to main body 210 via threads. Cartridge 250 includes lower cartridge body 255 and upper cartridge body 260 that are integrally formed together. Lower cartridge body 255 is coupled to main body 210 (e.g., threadably, via press fit, etc.). For example, a portion of lower cartridge body 255 extends into and is received by main body 210 to couple to main body 210. Upper cartridge body 260 is coupled to coil assembly 300 (e.g., threadably, via press fit, etc.). For example, a portion of upper cartridge body 260 extends into and is received by housing 305 of coil assembly 300 to couple to coil assembly 300.

That is, coil assembly 300 is coupled to cartridge 250 of body 200. In the illustrated example, coil assembly 300 includes housing 305, which includes coil housing 310 and wiring housing 315. Coil assembly 300 also includes coil 320, which is housed in coil housing 310 and configured to operate as an electromagnet. Wiring housing 315 houses wiring that is operatively connected to coil 320. For example, the control wiring transmits a control signal to energize or deenergize coil 320.

Coil housing 310 is a hollow cylinder that defines hole 340 extending along its longitudinal axis. Coil assembly 300 includes plug 325 that is securely positioned at least partially within hole 340 toward its upper end. Plug 325 is formed of magnetic material. Further, plug 325 is positioned in hole 340 of coil housing 310 and is formed of material with magnetic properties such that plug 325 creates a magnetic force to pull plunger 600 upward when coil 320 is energized. Coil assembly 300 further includes cap 330 and seal 335. Cap 330 covers and encloses an upper opening of hole 340 of coil housing 310. In the illustrated example, cap 330 is threadably coupled to plug 325 via threads and sealingly engages housing 305 of coil assembly 300. Seal 335 is configured to engage and form a sealed connection between cap 330 and housing 305.

Additionally, cartridge 250 of body 200 is coupled to housing 305 of coil assembly 300. In the illustrated example, valve 100 includes washer 910 that is positioned of cartridge 250 and housing 305 of coil assembly 300. In the illustrated example, upper cartridge body 260 of cartridge 250 extends at least into hole 340 of coil housing 310 through a lower opening of the hole. Upper cartridge body 260 may be securely positioned relative to coil assembly 300 by being press fit into hole 340 of coil housing 310. Further, an upper end of upper cartridge body 260 engages a lower end of plug 325 within hole 340 of coil housing 310. In some examples, upper cartridge body 260 of cartridge 250 is fixedly coupled to the lower end of plug 325 (e.g., via welding).

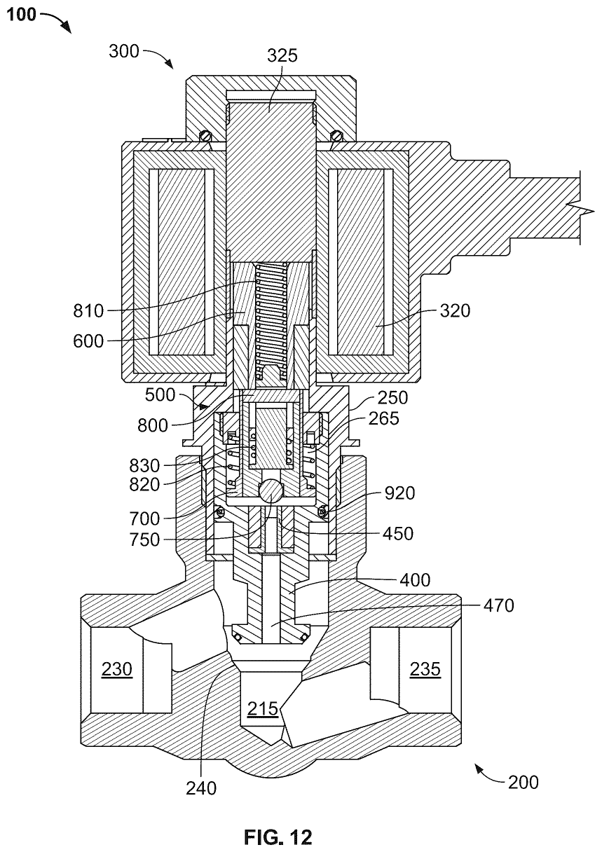

Poppet 400 of valve 100 is partially housed within lower cartridge body 255 and extends downwardly beyond cartridge 250. For example, poppet 400 extends downwardly below cartridge 250 through a central aperture in lower cartridge body 255 of cartridge 250. An upper portion of poppet 400 is housed within lower cartridge body 255, and a lower portion of poppet 400 extends from cartridge 250. As disclosed below in further detail, poppet 400 is configured to translate between a closed position (as shown in FIGS. 1 and 10-11) and an open position (as shown in FIG. 12). In the closed position, poppet 400 is sealingly engaged with valve seat 240 to fluidly disconnect inlet side 230 and outlet side 235 to prevent cryogenic fluid flow through conduit 215 of valve 100. In the open position, poppet 400 is disengaged from valve seat 240 to fluidly connect inlet side 230 and outlet side 235 of body 200 to permit cryogenic fluid flow through conduit 215 of valve 100.

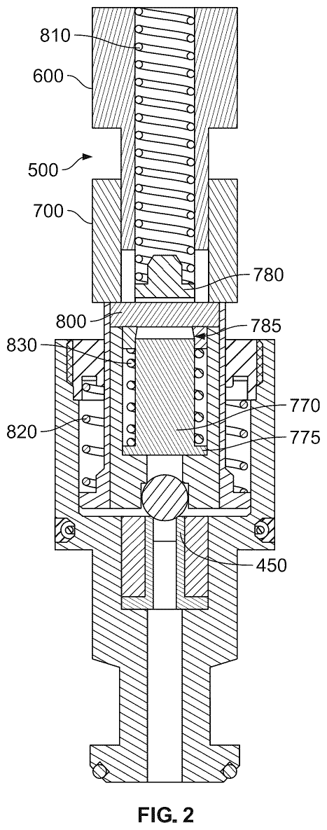

Additionally, poppet 400, body 200, and/or coil assembly 300 define chamber 265 (also referred to as “pressure chamber”). For example, chamber 265 is defined at least partially by poppet 400 and cartridge 250 of body 200. Further, chamber 265 is also defined by plug 325 of coil assembly 300. In other examples, cartridge 250 may be shaped and positioned relative to coil assembly 300 such that cartridge 250 and poppet 400 combine to form chamber 265. Further, gaps formed between poppet 400 and plunger 700 enable various portions of chamber 265 to be fluidly connected to each other. For example, a gap (e.g., a radial gap) formed between poppet 400 and plunger 700 fluidly connects upper portion 266 and intermediate portion 267 of chamber 265, and another gap (e.g., a radial gap) between poppet 400 and plunger 700 fluidly connects intermediate portion 267 and lower portion 268 of chamber 265. Poppet 400 also is coaxially aligned with and configured to translate relative to plungers 600, 700 and coil 320. FIG. 2 further depicts positioning of poppet 400 relative to plungers 600, 700 of plunger assembly 500.

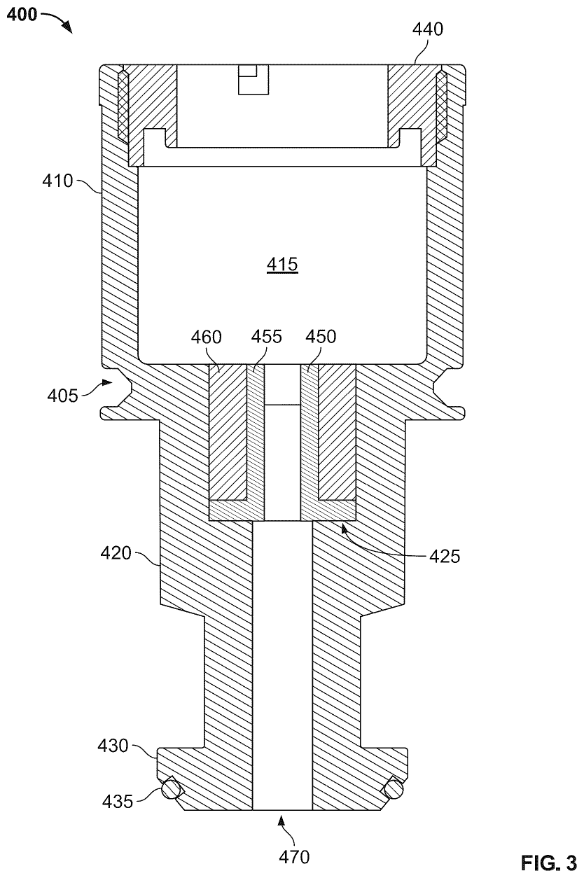

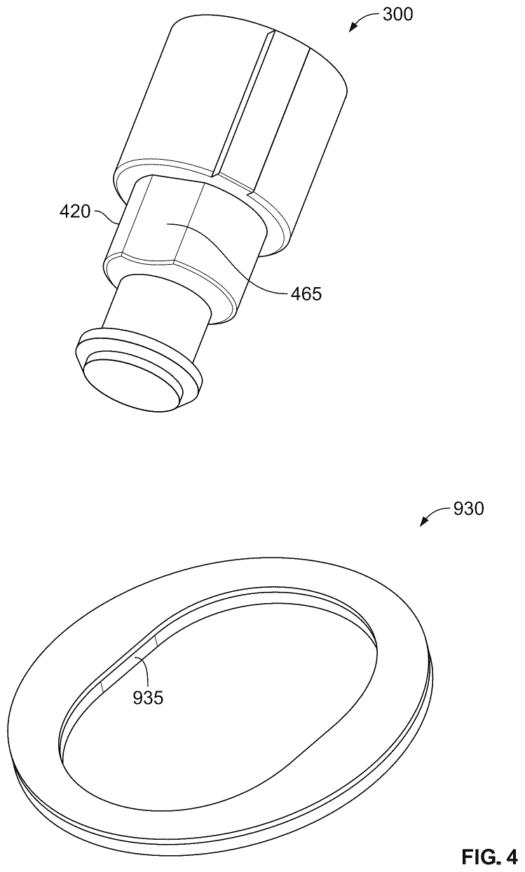

FIG. 3 further depicts poppet 400. In the illustrated example, poppet 400 includes upper body 410, lower body 420, and head 430 that are integrally formed together. Upper body 410 (also referred to as “upper poppet body”) is positioned at an upper end of poppet 400, and head 430 (also referred to as a “poppet head”) is positioned at an opposing lower end. Lower body 420 extends between and is connected to upper body 410 and head 430. Turning to FIG. 4, lower body 420 includes outer flat or concave surface 465 that is configured to slidingly engage inner flat or concave surface 935 of gasket 930. Gasket 930 is securely positioned in body 200 of valve 100 and is configured to slidingly receive poppet 400 in a keyed manner to prevent poppet 400 from rotating about a longitudinal axis of poppet 400 and/or plunger assembly 500. For example, as shown in FIG. 1, gasket 930 is securely positioned at an end of lower cartridge body 255 and ledge 245 defined by main body 210.

Returning to FIG. 3, head 430 includes seal 435 (e.g., an O-ring seal) configured to sealingly engage valve seat 240 when poppet 400 is in its closed position. When coil 320 is deenergized, as shown in FIG. 1, poppet 400 is configured to rest in a closed position at which seal 435 sealingly engages valve seat 240 to prevent cryogenic fluid from flowing through conduit 215. Seal 435 is sized and shaped to deter deformation at cryogenic temperatures, which, over time, may otherwise result in an unsealed connection with valve seat 240 in the closed position.

Upper body 410 is hollow and defines cavity 415, which is configured to slidably receive a lower portion of plunger 700. Poppet 400 also includes cap 440 that is coupled to upper body 410 at its upper end. Cap 440 is positioned relative to plunger 700 as plunger 700 slides through cavity 415 to impede plunger 700 from tilting from the longitudinal axis of poppet 400 and/or plunger assembly 500. In the illustrated example, cap 440 includes an annular groove that is configured to receive an upper end of spring 820.

Upper body 410 and/or lower body 420 of poppet 400 also define bore 425 that extends from a lower end of cavity 415. Bore 425 is configured to securely receive (e.g., via press fit) seat 450 of poppet 400. In the illustrated example, seat 450 (also referred to as “poppet seat,” “second seat,” or “second valve seat”) is an insert and includes seal 455 and retainer 460. Seat 450 is an insert to enable it to be removed from bore 425 for maintenance and/or replacement. That is, seat 450 is a replaceable insert. Seal 455 has an inverted T-shaped cross-section and is configured to be engaged by plunger 700 (e.g., ball 750 of plunger 700) when plunger 700 is in its extended position. Retainer 460 is positioned circumferentially around and engages seal 455. Further, retainer 460 is configured to engage upper body 410 and/or lower body 420 of poppet 400 when seat 450 is press fit into place within bore 425. Seal 455 and retainer 460 are arranged such that seat 450 has one or more sealing surfaces. For example, seat 450 has a circumferential sealing surface, an upwardly facing nose, and/or a bottom sealing surface.

As illustrated in FIG. 3, poppet 400 defines pilot hole 470. Pilot hole 470 extends from head 430, through lower body 420, and to cavity 415 defined by upper body 410. Poppet 400 is positioned such that an upper end of pilot hole 470 is to fluidly connect to chamber 265 via cavity 415 and a lower end of pilot hole 470 is fluidly connected to outlet side 235 of body 200 via conduit 215. Additionally, seat 450 is positioned at the upper end of pilot hole 470 such that seat 450 is adjacent pilot hole 470.

As disclosed below in greater detail, pilot hole 470 enables outlet side 235 of body 200 to be fluidly connected to chamber 265 when plunger 700 is disengaged from seat 450. In contrast, pilot hole 470 is closed when plunger 700 is sealingly engaged with seat 450 to fluidly disconnect outlet side 235 from chamber 265. The plunger 700 engages or disengages from seat to respectively close or open pilot hole 470. In turn, a pressure of fluid within chamber 265 is controlled in a manner that facilitates poppet 400 in (1) transitioning between its closed position and its open position and (2) ensuring formation of a tight seal with valve seat 240 in its closed position.

Poppet 400 of the illustrated example includes circumferential groove 405 that is configured to receive bleed seal 920. Returning to FIG. 1, bleed seal 920 divides chamber 265 from inlet side 230 of conduit 215. That is, bleed seal 920 defines the lower end of chamber 265. Bleed seal 920 is configured to engage poppet 400 and body 200. In particular, bleed seal 920 is configured to engage poppet 400 and cartridge 250 of body 200. Bleed seal 920 is positioned between inlet side 230 of conduit 215 and chamber 265 to form an orifice that permits fluid to flow between inlet side 230 and chamber 265 at a relatively slow rate (e.g., “bleed”). For example, bleed seal 920 may be sized and arranged to permit fluid to flow between inlet side 230 and chamber 265 at a controlled, predetermined rate. In turn and as disclosed below in greater detail, bleed seal 920 is configured to permit fluid pressure to equalize between inlet side 230 and chamber 265 slowly over time. For example, bleed seal 920 is positioned between poppet 400 and body 200 to cause a chamber pressure within chamber 265 to slowly equalize with that of inlet side 230 over time when poppet 400 is in its closed position.

As shown in FIG. 1, solenoid 150 of valve 100 is formed by coil assembly 300 and plunger assembly 500. Plunger assembly 500 is positioned in chamber 265 and includes plunger 600 (also referred to as “upper plunger” or “first plunger”) and plunger 700 (also referred to as “lower plunger” or “second plunger”). Plunger assembly 500 also includes pin 800 that is configured to slidably couple plunger 700 to plunger 600.

Plunger 600 extends at least partially into hole 340 of coil housing 310 through the lower opening of the hole. In the illustrated example, plunger 600 is also at least partially housed within upper cartridge body 260 of cartridge 250. Plunger 600 is coaxially aligned with coil 320 of coil assembly 300. Plunger 600 is configured to translate between its extended position (also referred to as a “first extended position”) and a retracted position (also referred to as a “first retracted position”). As disclosed in further detail below, coil 320 is configured to control the positioning of plunger 600. More specifically, plunger 600 is positioned relative to coil assembly 300 such that coil 320 is configured to cause plunger 600 to translate between its extended position and its retracted position.

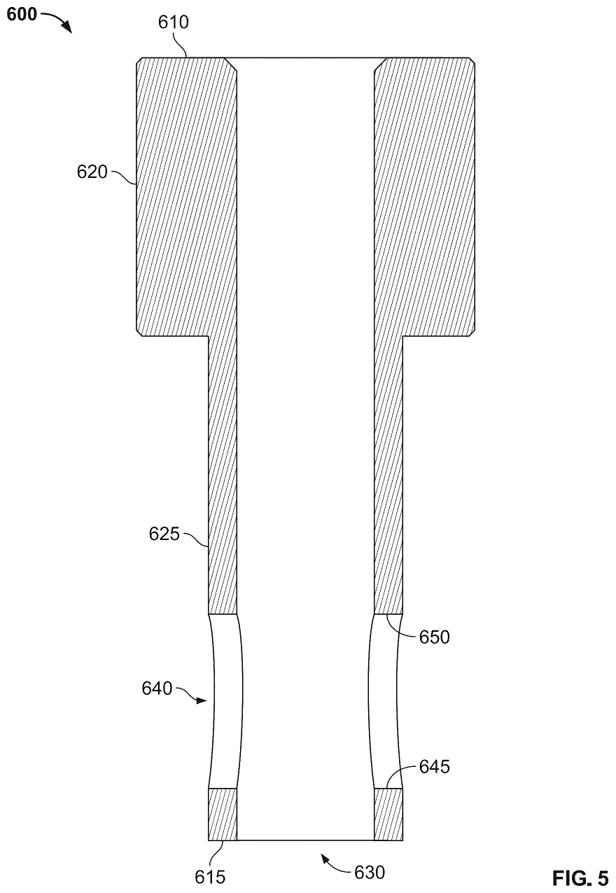

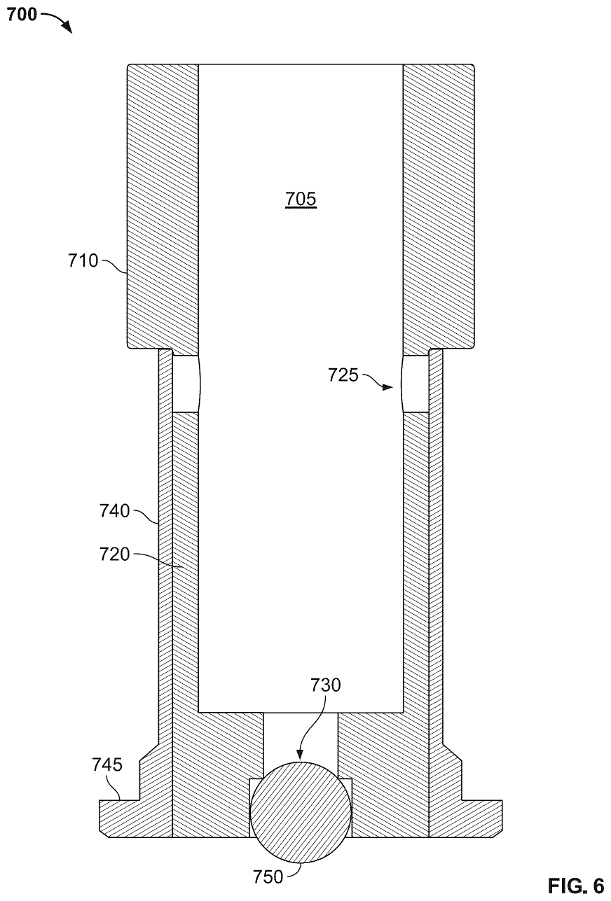

Turning to FIG. 5, plunger 600 of the illustrated example includes upper end 610 and opposing lower end 615. Plunger 600 includes upper body 620 adjacent to upper end 610 and lower body 625 adjacent to lower end 615. Upper body 620 and lower body 625 are integrally formed together. Upper body 620 has an outer diameter that is greater than that of lower body 625. Upper body 620 is sized to be securely and slidably received by upper cartridge body 260 and/or coil housing 310. Lower body 625 is sized to be securely and slidably received by plunger 700 (e.g., by cavity 705 of plunger 700 of FIG. 6). Plunger 600 defines through-hole 630 that extends its length between upper end 610 and lower end 615. Further, through-hole 630 extends along a longitudinal axis of plunger 600. As shown in FIGS. 1-2, spring 810 of valve 100 is configured to extends through through-hole 630.

Returning to FIG. 5, plunger 600 defines opposing slot 640 (also referred to as “vertical slots”) that extends transverse (e.g., perpendicular) to through-hole 630. Each slot 640 extends vertically along lower body 625 of plunger 600. For example, each slot 640 includes lower end 645 and opposing upper end 650. As disclosed below in greater detail, pin 800 is configured to extend through slots 640 to couple plunger 600 and plunger 700 together. Slot is shaped to enable plunger 700 to slide relative to plunger 600 while remaining coupled together. For example, pin 800 is configured to slide from lower end 645 to upper end 650 of slots 640 to permit plunger 700 to translate plunger 600 to its retracted position. Conversely, pin 800 is configured to slide from upper end 650 to lower end 645 of slots 640 as plunger 700 moves downwardly to permit plunger 700 to translate relative to plunger 600 to its extended position.

Returning to FIGS. 1-2, plunger 600 is partially nested within plunger 700, which extends toward poppet 400. Plunger 700 extends at least partially into hole 340 of coil housing 310 through the lower opening of the hole. Plunger 700 is also housed within cartridge 250. Plunger 700 is coaxially aligned with plunger 600 and coil 320. Plunger 700 is configured to translate between its extended position (also referred to as a “second extended position”), its partially retracted position, and its fully retracted position (also referred to as a “second retracted position”).

Turning to FIG. 6, plunger 700 includes upper body 710 adjacent its upper end and lower body 720 adjacent its lower end. Upper body 710 and lower body 720 are integrally formed together. Upper body 710 has an outer diameter that is greater than that of lower body 720. Upper body 710 is sized to be securely and slidably received by upper cartridge body 260 and/or coil housing 310. Lower body 720 is sized to be securely and slidably received by cavity 415 and/or cap 440 of poppet 400.

Plunger 700 includes ball 750 at its lower end. In the illustrated example, ball 750 is securely received by cavity 730 (e.g., via press fit) that is located along the lower end of plunger 700. Ball 750 is configured to sealingly engage seat 450 in the extended position of plunger 700 and is configured to be disengaged from seat 450 in the partially retracted position and the fully retracted position of plunger 700. In some examples, ball 750 is formed of a metallic material and seal 455 of seat 450 is formed of a plastic material to facilitate plunger 700 in consistently forming a sealed connection with seat 450. Additionally, ball 750 sealingly closes pilot hole 470 when engaging seat 450 to fluidly disconnect chamber 265 from outlet side 235 of valve 100. Ball 750 opens pilot hole 470 when disengaged from seat 450 to fluidly connect chamber 265 from outlet side 235 of valve 100.

Plunger 700 also defines cavity 705 (also referred to as “first plunger cavity”) that extends from its upper end toward its lower end. For example, cavity 705 vertically extends the length of upper body 710 and a portion of the length of lower body 720. Cavity 705 is configured to slidably receive lower body 625 of plunger 600 to enable plungers 600, 700 to be slidably coupled together. Additionally, as most clearly shown in FIGS. 2 and 8-9, cavity 705 also is configured to house spring support 770 of plunger 700. Spring support 770 includes foot 775 at its lower end and seat 780 at its opposing upper end. Foot 775 is configured to engage and support an end of spring 830, and seat 780 is configured to engage and support an end of spring 810. Additionally, spring support 770 defines through-hole 785 through which pin 800 extends.

Returning to FIG. 6, plunger 700 also defines opposing holes 725 that are transverse (e.g., perpendicular) to cavity 705. As disclosed below in greater detail, each hole 725 is configured to receive a respective end of pin 800 to slidably couple plungers 600, 700 together. Further, plunger 700 includes sleeve 740 that is configured to securely retain pin 800 within holes 725 and slots 640. In the illustrated example, sleeve 740 extends circumferentially around and engages an outer surface of lower body 720. Sleeve 740 extends vertically from the lower end of plunger 700 to beyond holes 725 to cover holes 725 in a manner that securely retains pin 800 within holes 725. Sleeve 740 also is positioned relative to cap 440 of poppet 400 to form the gap that fluidly connects upper portion 266 and intermediate portion 267 of chamber 265 together.

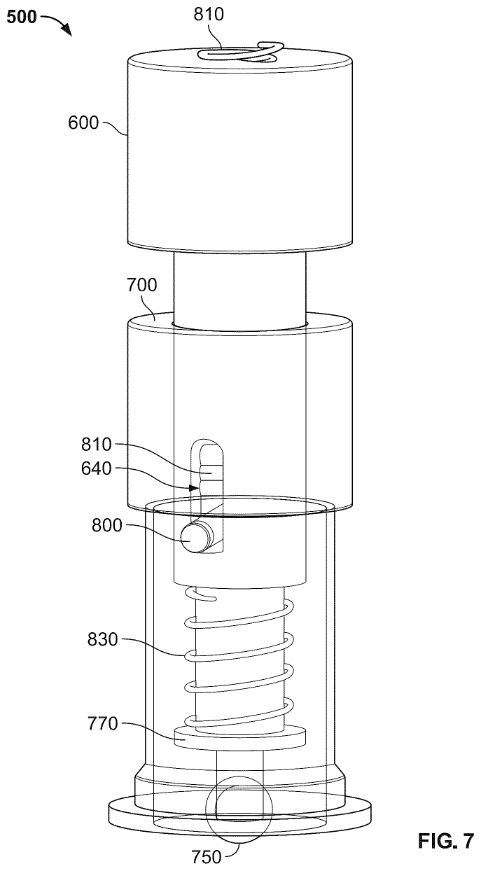

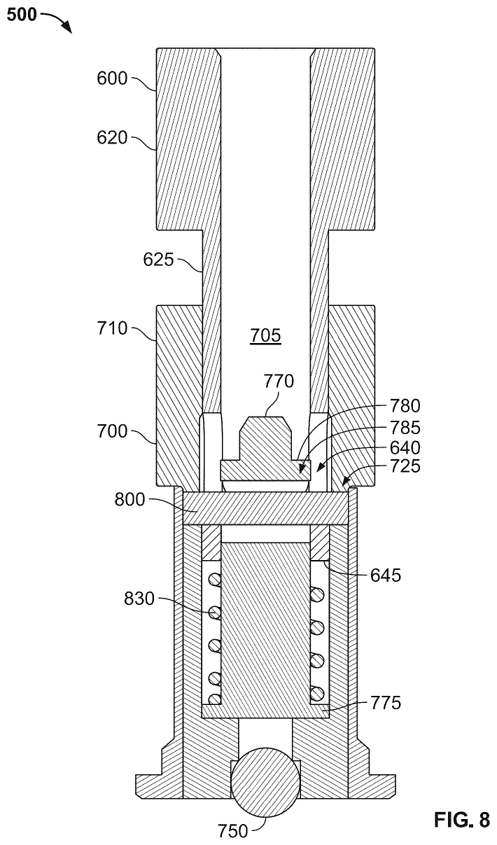

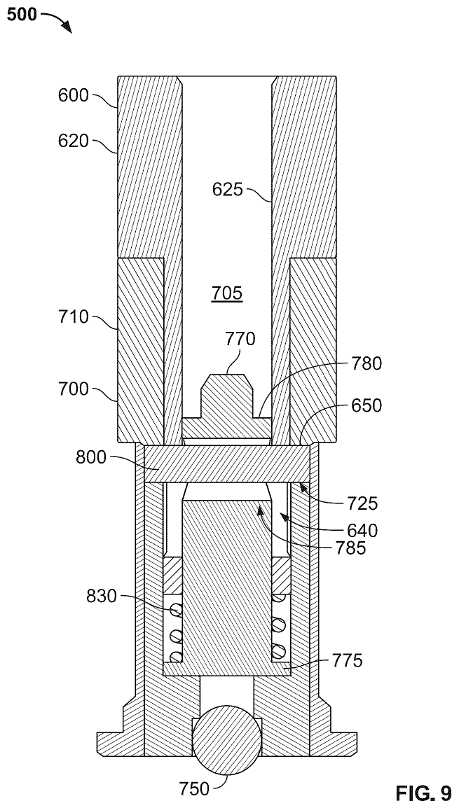

As shown in FIGS. 7-9, plunger 700 is positioned relative to plunger 600 such that holes 725 align with slots 640. Pin extends into each hole 725 of plunger 700, through each slot 640 of plunger 600, and through through-hole 785 of spring support 770 to securely couple plungers 600, 700 together. More specifically, plunger 700 is slidably coupled to plunger 600 via pin 800. Plunger 700 is configured to translate with plunger 600 as plunger 700 transitions from its extended position to its partially retracted position, and plunger 700 is configured to slide relative to plunger 600 as plunger 700 transitions from its partially retracted position to its fully retracted position. FIGS. 7-8 depict plunger assembly 500 when plunger 700 is in its extended position and/or partially retracted position, with pin 800 engaging lower end 645 of slot 640 of plunger 600. FIG. 9 depicts plunger assembly 500 when plunger 700 is in its retracted position, with pin 800 engaging upper end 650 of slot 640. Pin 800 is enabled to slide vertically within slot 640 between lower end 645 and upper end 650 to permit plunger 700 to slide relative to plunger 600.

Returning to FIG. 1, valve 100 includes one or more springs configured to bias poppet 400 and/or plunger 700 in particular directions. For example, valve 100 includes spring 810 (also referred to as “first spring”), spring 820 (also referred to as “second spring”), and spring 830 (also referred to as “third spring”).

Spring 810 extends through through-hole 630 of plunger 600. Further, spring 810 extends between and engages plug 325 of coil assembly 300 and seat 780 of spring support 770 (FIG. 2) of plunger 700. Spring 810 is arranged in such a manner to bias plunger 700 toward its extended position to close pilot hole 470 and/or to bias poppet 400 toward its closed position to close conduit 215. For example, as disclosed below in greater detail, spring 810 is configured to push plunger 700 from its fully retracted position to its extended position to sealingly engage seat 450 and/or push poppet 400 from its open position to its closed position to sealingly engage valve seat 240.

Spring 820 is positioned in cavity 415 of poppet 400. Further, spring 820 extends between and engages cap 440 of poppet 400 and foot 745 of plunger 700. Spring 820 is arranged in such a manner to (1) bias plunger 700 downward to remain in its extended position when valve 100 is in its closed state, (2) allow poppet 400 to open when valve 100 is in its intermediate state, and/or (3) bias poppet 400 upward when plunger 700 is in its fully retracted position to retain poppet 400 in its open position when valve 100 is in its closed state. Further, foot 745 is positioned in cavity 415 and relative to upper body 410 of poppet 400 to form the gap that fluidly connects intermediate portion 267 and lower portion 268 of chamber 265 together.

Spring 830 extends between and engages lower end 615 of plunger 600 and foot 775 of spring support 770 (FIG. 2) of plunger 700. Spring 830 is arranged in such a manner to bias plunger 600 upwardly toward its extended position when plunger 700 is in its extended position. Spring 830 retains plunger 600 in its extended position to prevent plunger 600 from translating downward when coil 320 is deenergized.

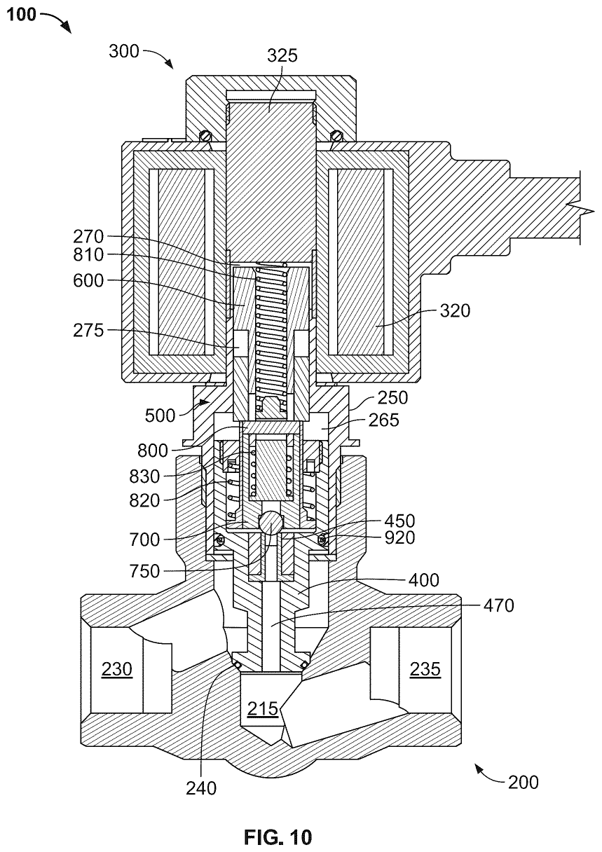

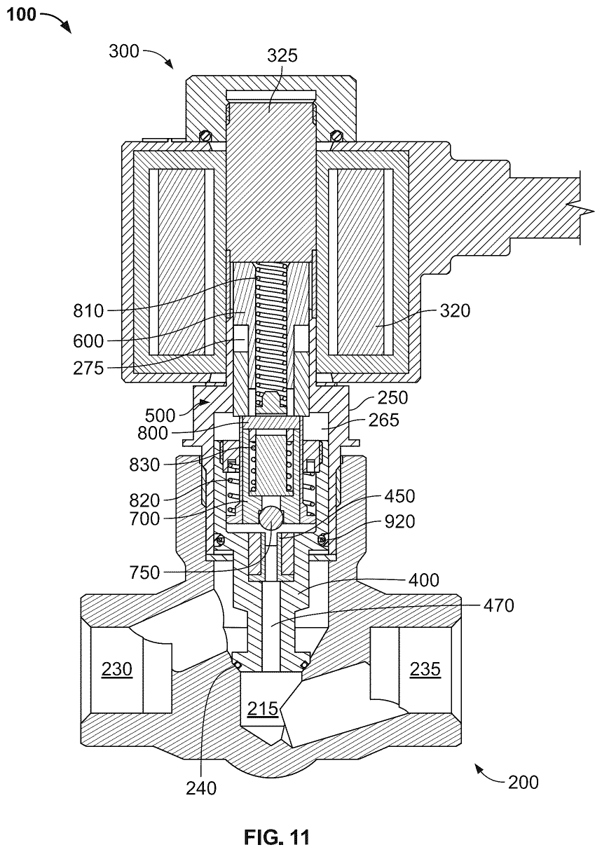

FIGS. 10-12 depict valve 100 in various states of operation. In particular, FIG. 10 depicts valve 100 in a closed state, FIG. 11 depicts valve 100 in an intermediate state, and FIG. 12 depicts valve 100 in an open state. Coil 320 of coil assembly 300 is configured to transition between a deenergized state and an energized state to cause valve 100 to transition between its closed state and its open state, respectively. That is, valve 100 is configured to transition from its closed state to its open state in response to coil 320 of coil assembly 300 transitioning to its energized state. Conversely, valve 100 is configured to transition from its open state to its closed state in response to coil 320 of coil assembly 300 transitioning to its deenergized state.

Turning to FIG. 10, valve 100 is in its closed state with coil 320 of coil assembly 300 being in its deenergized state. When coil 320 is deenergized, coil 320 does not emit a magnetic field with a force (e.g., about 15 N) to pull plunger 600 upward. As a result, the biasing force of spring 810 pushes plunger 700 to its extended position and, in turn, push poppet 400 to rest in its closed position. That is, when valve 100 is in its closed state, poppet 400 is in its closed position where it is sealingly engaged with valve seat 240 to fluidly disconnect inlet side 230 and outlet side 235 to prevent cryogenic fluid from flowing through conduit 215. Additionally, plunger 700 is in its extended position where ball 750 of plunger 700 is sealingly engaged with seat 450 to close pilot hole to fluidly disconnect chamber 265 from outlet side 235. Further, when poppet 400 and plunger 700 are in their closed position and extended position, respectively, the biasing force of spring 830 pushes plunger 600 to slide upward relative to plunger 700 until pin 800 contacts lower end 645 of slots 640, at which point plunger 600 is in its extended position. When plunger 600 is in its extended position, gap 270 is formed between plunger 600 and plug 325 of coil assembly 300. Gap 270 is relatively small with a distance, for example, of about 0.031 inches. Additionally, when plungers 600, 700 are in their respective extended position, gap 275 is formed between upper body 620 of plunger 600 and upper body 710 of plunger 700 when plungers 600, 700 are in their respective extended positions. Gap 275 is relatively small with a distance, for example, of about 0.173 inches.

When valve 100 is in its closed state, an inlet-side pressure of cryogenic fluid at inlet side 230 of conduit 215 is greater than an outlet-side pressure of cryogenic fluid at outlet side 235 of conduit 215. Further, the inlet-side pressure of cryogenic fluid at inlet side 230 is greater than or equal to a chamber pressure of fluid within chamber 265. For example, initially after valve transitions to its closed state, the inlet-side pressure at inlet side 230 is greater than the chamber pressure in chamber 265. Over time as valve 100 remains in its closed state, bleed seal 920 enables fluid to slowly bleed between inlet side 230 and chamber 265. In turn, chamber pressure in chamber 265 slowly increases to equalize with the inlet-side pressure at inlet side 230, which subsequently facilitates valve 100 in transitioning from its closed state. The chamber pressure in chamber 265 increases such that it is greater than the outlet-side pressure to further maintain poppet 400 in its closed position.

FIG. 11 depicts valve 100 in its intermediate state. To transition valve 100 from its closed state (FIG. 10) to its intermediate state (FIG. 11), coil 320 of coil assembly 300 transitions to its energized state. When coil 320 is energized, coil 320 generates a magnetic field that pulls plunger 600 upward to its retracted position. As shown in the illustrated example, plunger 600 engages plug 325 of coil assembly 300 in its retracted position such that gap 270 is null. Additionally, the magnetic field of coil 320 initially pulls plungers 600, 700 upward together such that plunger 700 transitions to its partially retracted position. That is, plungers 600, 700 and pin 800 are arranged such that plunger 700 translate upward with plunger 600 when coil 320 transitions to an energized state. For example, plungers 600, 700 and springs 810, 820 are arranged such that the biasing forces of springs 810, 820 are overcome by the force applied by coil 320 onto plunger 600 such that plunger 700 moves upward with plunger 600 as a unit. In turn, gap 275 remains between upper body 620 of plunger and upper body 710 of plunger 700.

At the same time, poppet 400 is arranged to initially remain in its closed position when coil 320 becomes energized due to the chamber pressure in chamber 265 being greater than the outlet-side pressure and/or the biasing force of spring 820 being relatively weak. In turn, poppet 400 remains sealingly engaged with valve seat 240 to keep outlet side 235 fluidly disconnected from inlet side 230 such that cryogenic fluid remains prevented from flowing through conduit 215. With plunger 700 being in its partially retracted position and poppet 400 remaining in its closed position, ball 750 of plunger 700 is disengaged from seat 450 to fluidly connect chamber 265 to outlet side 235 via the opening of pilot hole 470.

With pilot hole 470 opened, the chamber pressure in chamber 265 then decreases to equalize with the outlet-side pressure when valve 100 is in its intermediate state. For example, initially after valve transitions to its intermediate state, the chamber pressure in chamber 265 decreases such that the inlet-side pressure at inlet side 230 is greater than the chamber pressure. Both the inlet-side pressure of inlet side 230 and chamber pressure in chamber 265 remain greater than the outlet-side pressure at outlet side 235. Over time, the chamber pressure in chamber 265 decreases to a predetermined threshold at which poppet 400 is able to push plunger 700 toward its open position.

FIG. 12 depicts valve 100 in its open state at which plunger 600 remains in its retracted position, plunger 700 is in its retracted position, and poppet 400 is in its open position. Ball 750 of plunger 700 remains disengaged from seat 450 to keep chamber 265 fluidly connected to outlet side 235 of conduit 215. Additionally, poppet 400 is disengaged from valve seat 240 to fluidly connect outlet side 235 and inlet side 230 of conduit 215. In turn, cryogenic fluid is permitted to flow through conduit 215 when valve 100 is in its open state. The inlet-side pressure at inlet side 230 is greater than or equal to the outlet-side pressure of outlet side 235 when poppet 400 is open to permit cryogenic fluid to flow through conduit 215.

To transition valve 100 from its intermediate state (FIG. 11) to its open state (FIG. 12), coil 320 of coil assembly 300 remains in its energized state. In turn, plunger 700 remains disengaged from seat 450 to keep chamber 265 fluidly connected to outlet side 235 via pilot hole 470. During that time, chamber pressure in chamber 265 decreases toward the outlet-side pressure at outlet side 235. Eventually, the chamber pressure in chamber 265 reduces to a predetermined pressure threshold such that a pressure differential between the inlet-side pressure at inlet side 230 and the chamber pressure in chamber 265 results in poppet 400 being pushed upward to disengage from valve seat 240 and translate to its open position. In turn, poppet 400 pushes plunger 700 upward relative to plunger 600 to its fully retracted position.

For example, when coil 320 initially becomes energized and valve 100 transitions to its intermediate state, the electromagnetic force acts on both plunger 600 and plunger 700. Because plunger 600 is positioned farther upward closer to plug 325, a greater magnetic force is applied to plunger 600 than to plunger 700. As a result, gap 275 remains as plunger 600 moves upward toward plug 325 because the electromagnetic force acting on plunger 700 is not strong enough to overcome the biasing force(s) of spring 810 and/or spring 820. Once poppet 400 moves upward as valve 100 transitions to its open state, poppet 400 pushes plunger 700 upward relative to plunger 600. When poppet 400 is in its open position, plunger 700 is very close to the position of plunger 600. In turn, the magnetic force acting on plunger 700 increases to cause plunger 700 to continue to move upward to its fully retracted positioned. When plunger 700 is in its fully retracted position, plunger 700 is positioned proximate to coil 320 such the magnetic force of coil 320 keeps plunger 700 in its fully retracted position.

In some examples, the predetermined pressure threshold corresponds, at least partially, with the biasing force(s) of spring 810, spring 820, and/or spring 830. The pressure differential between the outlet-side pressure and the chamber pressure overcomes the biasing force(s) of one or more of springs 810, 820, 830 to cause plunger 700 to slide upward relative to plunger 600. Further, in the fully retracted position of plunger 700, upper body 620 of plunger 600 and upper body 710 of plunger 700 such that gap 275 is null. The pressure differential between the inlet-side pressure and the chamber pressure overcomes the biasing force(s) of one or more of springs 810, 820, 830 to cause plunger 700 to slide upward relative to plunger 600. In its open position, the upper end of poppet 400 engages cartridge 250 of body 200. For example, poppet 400 is configured to travel a distance of about 0.177 inches between its closed position and its open position.

Subsequently, when coil 320 is deenergized, the biasing force of spring 810 pushes poppet 400 from its open position to its closed position with enough force such that a tight, sealed connection is formed between seal 435 and valve seat 240. That is, spring 810 pushes poppet 400 to sealingly engage valve seat 240 of body 200. In turn, poppet 400 fluidly disconnects outlet side 235 from inlet side 230 to again prevent cryogenic fluid from flowing through conduit 215. Further, the biasing force of spring 810 pushes plunger 700 from its fully retracted position to its extended position with enough force such that a tight, sealed connection is formed between ball 750 of plunger 700 and seat 450 of poppet 400. In turn, plunger assembly 500 fluidly disconnects outlet side 235 from chamber 265 to keep poppet 400 closed until coil 320 is reenergized.

Plunger assembly 500 of the illustrated example is configured to ensure that a tight, sealed connection is formed between poppet 400 and valve seat 240 as valve is transitioned from its open state to its closed state. For example, plunger assembly 500 includes two plungers 600, 700 that are slidably connected together in such a manner that minimizes the actuation distance of plunger 600 (e.g., equal to the length of gap 270). The reduced actuation distance of plunger 600 enables the magnetic force generated by coil 320 (e.g., about 15 N) to overcome a greater biasing force of spring 810 to transition valve 100 from its close state to its open state. As a result, spring 810 is able to have a greater biasing force that biases poppet 400 toward its closed position to facilitate poppet 400 in consistently forming a sealed connection with engaging valve seat 240 when valve 100 transitions to the closed state.

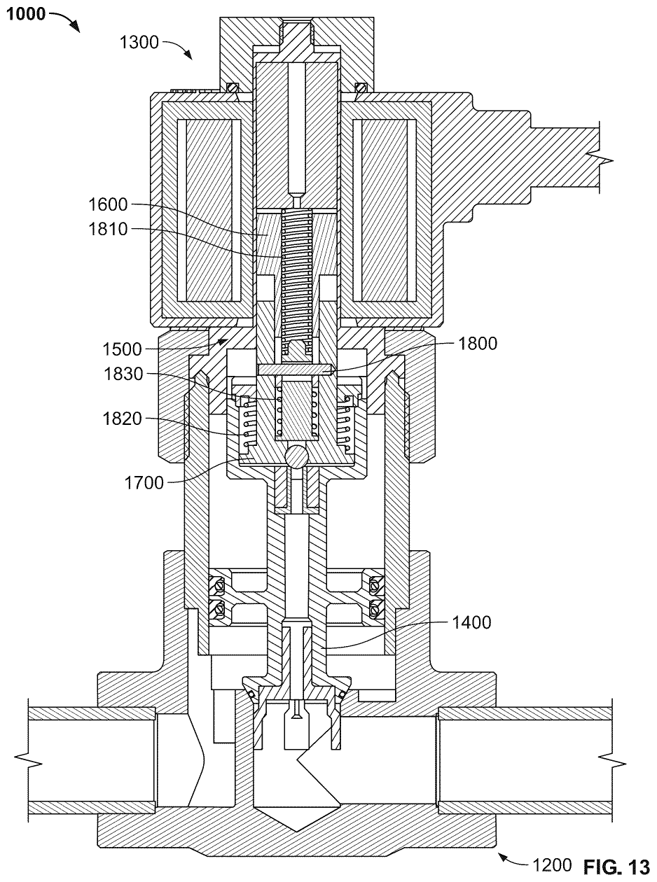

FIG. 13 illustrates another example embodiment of valve 1000 (also referred to as “solenoid pilot valve”). Valve 1000 is configured to control the flow of cryogenic fluid, such as liquid hydrogen (LH2). Valve 1000 includes components that are identical or substantially similar to that of valve 100. For example, valve 1000 includes body 1200; coil assembly 1300; plunger assembly 1500; springs 1810, 1820, 1830; and bleed seal 1920, which are identical or substantially similar to body 200; coil assembly 300; plunger assembly 500; springs 810, 820, 830; and bleed seal 1920, respectively, of valve 100. Further, plunger assembly 1500 includes plunger 1600, plunger 1700, and pin 1800, which is identical or substantially similar to plunger 600, plunger 700, and pin 800, respectively, of valve 100. As such, some features of those components of valve 1000 are not disclosed again in further detail below.

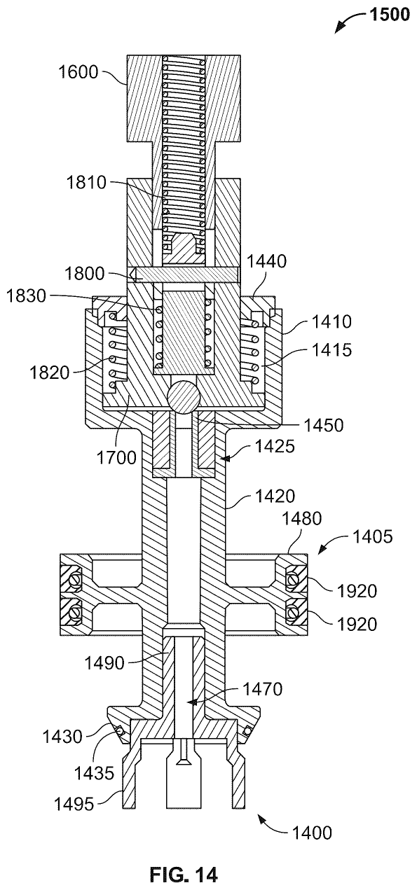

FIG. 14 further depicts poppet 1400 of valve 1000 when assembled together with plunger assembly 1500. Poppet 1400 is configured to operate identically or substantially similarly to poppet 400 of valve 100. As such, some features of those operations of poppet 1400 are not disclosed again in further detail below. Further, poppet 1400 includes components that are identical or substantially similar to that of poppet 400. For example, poppet 1400 includes upper body 1410, cavity 1415, lower body 1420, bore 1425, head 1430, seal 1435, cap 1440, seat 1450, and pilot hole 1470 that are identical or substantially similar to upper body 410, cavity 415, lower body 420, bore 425, head 430, seal 435, cap 440, seat 450, and pilot hole 470 of poppet 400, respectively. As such, some features of those components of valve 1000 are not disclosed again in further detail below.

As illustrated in FIG. 14, poppet 1400 also includes winged flange 1480 that extends radially outward from lower body 1420. Winged flange defines one or more circumferential grooves 1405 each of which receives a respective bleed seal 1920. Further poppet 1400 includes insert 1490 that is configured to be securely inserted into a lower end of pilot hole 1470 adjacent head 1430. In the illustrated example, insert 1490 includes one or more legs 1495 each of which extends in a downward direction beyond head 1430 of poppet 1400.

An example solenoid pilot valve for cryogenic fluid includes a valve body. The valve body includes a first seat and defines a conduit that has an inlet side and an outlet side. The solenoid pilot valve includes a coil assembly coupled to the valve body. The solenoid pilot valve includes a poppet configured to translate between a closed position at which the poppet sealingly engages the first seat to fluidly disconnect the inlet side and the outlet side and an open position at which the poppet is disengaged from the first seat to fluidly connect the inlet side and the outlet side. The poppet and the valve body at least partially define a chamber. The poppet defines a pilot hole that is configured to fluidly connect the chamber and the outlet side. The poppet includes a second seat adjacent the pilot hole. The solenoid pilot valve includes a plunger assembly positioned in the chamber. The plunger assembly includes a first plunger positioned such that the coil assembly is configured to cause the first plunger to translate between a first extended position and a first retracted position. The plunger assembly includes a second plunger slidably coupled to the first plunger and extending toward the poppet. The second plunger is configured to translate between a second extended position, a partially retracted position, and a second retracted position. The second plunger is configured to sealingly engage the second seat to close the pilot hole in the second extended position and is configured to be disengaged from the second seat to open the pilot hole in the partially retracted position and the second retracted position.

In some examples, the valve body further includes a main body that includes the first seat, the inlet side, and the outlet side. The valve body further includes a cartridge extending between and coupled to the main body and the coil assembly. The cartridge at least partially defines the chamber with the poppet.

In some examples, the coil assembly includes a coil that is configured to position the first plunger in the first extended position in a deenergized state and in the first retracted position in an energized state.

In some examples, the second plunger includes a ball that is configured to sealingly engage the second seat of the poppet when the second plunger is in the second extended position.

In some examples, the plunger assembly further includes a pin configured to slidably couple the second plunger to the first plunger. In some such examples, the pin is fixed to the second plunger. The first plunger defines vertical slots through which the pin slidably extends to enable the second plunger to slide relative to the first plunger. The vertical slots includes an upper end and a lower end. The pin is configured to slide from the lower end to the upper end as the second plunger translates to the second retracted position and the poppet translates to the open position.

Some examples further include a bleed seal positioned between the poppet and the valve body to cause a chamber pressure within the chamber to slowly equalize with that of the inner side of the valve body over time when the poppet is in the closed position.

Some examples further include a first spring extending between and engaging the coil assembly and the second plunger to bias the second plunger toward the second extended position and the poppet toward the closed position. Some examples further include a second spring extending between and engaging the second plunger and the poppet to further bias the second plunger toward the second extended position. Some examples further include a third spring extending between and engaging the first plunger and the second plunger to bias the first toward the first extended position when the second plunger is in the second extended position.

In some examples, when the solenoid pilot valve is in a closed state, the poppet is in the closed position and sealingly engaged with the first seat to fluidly disconnect the inlet side and the outlet side of the valve body, the first plunger is in the first extended position, the second plunger is in the second extended position and sealingly engaged with the second seat to fluidly disconnect the chamber from the outlet side of the valve body, and an inlet-side pressure of the inlet side is greater than an outlet-side pressure of the outlet side and is greater than or equal to a chamber pressure of the chamber.

In some examples, when the solenoid pilot valve is in an intermediate state, the poppet is in the closed position and sealingly engaged with the first seat to fluidly disconnect the inlet side and the outlet side of the valve body, the first plunger is in the first retracted position, the second plunger is in the partially retracted position and disengaged from the second seat to fluidly connect the chamber to the outlet side to enable the chamber to equalize with the outlet side, and an inlet-side pressure at the inlet side is greater than a chamber pressure in the chamber and the chamber pressure is greater than or equal to an outlet-side pressure of the outlet side.

In some examples, the solenoid pilot valve is configured to transition from a closed state to an intermediate state when the coil assembly transitions to an energized state. The coil assembly transitioning to the energized state is configured to cause the first plunger to translate to the first retracted position and the second plunger to translate to the partially retracted position together as a unit.

In some examples, when the solenoid pilot valve is in an open state, the poppet is in the open position and disengaged from the first seat to fluidly connect the inlet side and the outlet side of the valve body, the first plunger is in the first retracted position, the second plunger is in the second retracted position and disengaged from the second seat to fluidly connect the chamber to the outlet side, and an inlet-side pressure at the inlet side is greater than or equal to an outlet-side pressure of the outlet side.

In some examples, the solenoid pilot valve is configured to transition from an intermediate state to an open state when the coil assembly remains in an energized state and a chamber pressure in the chamber reduces to a predetermined pressure threshold such that a pressure differential between the chamber pressure and an inlet-side pressure at the inlet side results in the poppet being pushed upward to disengage from the first seat and translate to the open position.

In some examples, the solenoid pilot valve is configured to transition from a closed state to an open state in response to the coil assembly transitioning to an energized state. Some such examples further include a spring that, when the coil assembly transitions to a deenergized state, is configured to push the poppet from the open position to the closed position to sealingly engage the first seat of the valve body.

1. A solenoid pilot valve for cryogenic fluid, comprising:
a valve body including a first seat and defining a conduit that has an inlet side and an outlet side;
a coil assembly coupled to the valve body;
a poppet configured to translate between a closed position at which the poppet sealingly engages the first seat to fluidly disconnect the inlet side and the outlet side and an open position at which the poppet is disengaged from the first seat to fluidly connect the inlet side and the outlet side, wherein the poppet and the valve body at least partially define a chamber, wherein the poppet defines a pilot hole that is configured to fluidly connect the chamber and the outlet side, and wherein the poppet includes a second seat adjacent the pilot hole;
a plunger assembly positioned in the chamber and comprising:
a first plunger positioned such that the coil assembly is configured to cause the first plunger to translate between a first extended position and a first retracted position; and
a second plunger slidably coupled to the first plunger and extending toward the poppet, wherein the second plunger is configured to translate between a second extended position, a partially retracted position, and a second retracted position, wherein the second plunger is configured to sealingly engage the second seat to close the pilot hole in the second extended position and is configured to be disengaged from the second seat to open the pilot hole in the partially retracted position and the second retracted position.

2. The solenoid pilot valve of claim 1, wherein the valve body further includes:
a main body that includes the first seat, the inlet side, and the outlet side; and
a cartridge extending between and coupled to the main body and the coil assembly, wherein the cartridge at least partially defines the chamber with the poppet.

3. The solenoid pilot valve of claim 1, wherein the coil assembly includes a coil that is configured to position the first plunger in the first extended position in a deenergized state and in the first retracted position in an energized state.

4. The solenoid pilot valve of claim 1, wherein the second plunger includes a ball that is configured to sealingly engage the second seat of the poppet when the second plunger is in the second extended position.

5. The solenoid pilot valve of claim 1, wherein the plunger assembly further includes a pin configured to slidably couple the second plunger to the first plunger.

6. The solenoid pilot valve of claim 5, wherein the pin is fixed to the second plunger, wherein the first plunger defines vertical slots through which the pin slidably extends to enable the second plunger to slide relative to the first plunger, wherein the vertical slots includes an upper end and a lower end, wherein the pin is configured to slide from the lower end to the upper end as the second plunger translates to the second retracted position and the poppet translates to the open position.

7. The solenoid pilot valve of claim 1, further comprising a bleed seal positioned between the poppet and the valve body to cause a chamber pressure within the chamber to slowly equalize with that of the inner side of the valve body over time when the poppet is in the closed position.

8. The solenoid pilot valve of claim 1, further comprising:
a first spring extending between and engaging the coil assembly and the second plunger to bias the second plunger toward the second extended position and the poppet toward the closed position;
a second spring extending between and engaging the second plunger and the poppet to further bias the second plunger toward the second extended position; and
a third spring extending between and engaging the first plunger and the second plunger to bias the first plunger toward the first extended position when the second plunger is in the second extended position.

9. The solenoid pilot valve of claim 1, wherein, when the solenoid pilot valve is in a closed state:
the poppet is in the closed position and sealingly engaged with the first seat to fluidly disconnect the inlet side and the outlet side of the valve body;
the first plunger is in the first extended position;
the second plunger is in the second extended position and sealingly engaged with the second seat to fluidly disconnect the chamber from the outlet side of the valve body; and
an inlet-side pressure of the inlet side is greater than an outlet-side pressure of the outlet side and is greater than or equal to a chamber pressure of the chamber.

10. The solenoid pilot valve of claim 1, wherein, when the solenoid pilot valve is in an intermediate state:
the poppet is in the closed position and sealingly engaged with the first seat to fluidly disconnect the inlet side and the outlet side of the valve body;
the first plunger is in the first retracted position;
the second plunger is in the partially retracted position and disengaged from the second seat to fluidly connect the chamber to the outlet side to enable the chamber to equalize with the outlet side; and
an inlet-side pressure at the inlet side is greater than a chamber pressure in the chamber and the chamber pressure is greater than or equal to an outlet-side pressure of the outlet side.

11. The solenoid pilot valve of claim 1, wherein the solenoid pilot valve is configured to transition from a closed state to an intermediate state when the coil assembly transitions to an energized state, wherein the coil assembly transitioning to the energized state is configured to cause the first plunger to translate to the first retracted position and the second plunger to translate to the partially retracted position together as a unit.

12. The solenoid pilot valve of claim 1, wherein, when the solenoid pilot valve is in an open state:
the poppet is in the open position and disengaged from the first seat to fluidly connect the inlet side and the outlet side of the valve body;
the first plunger is in the first retracted position,
the second plunger is in the second retracted position and disengaged from the second seat to fluidly connect the chamber to the outlet side; and
an inlet-side pressure at the inlet side is greater than or equal to an outlet-side pressure of the outlet side.

13. The solenoid pilot valve of claim 1, wherein the solenoid pilot valve is configured to transition from an intermediate state to an open state when:
the coil assembly remains in an energized state; and
a chamber pressure in the chamber reduces to a predetermined pressure threshold such that a pressure differential between the chamber pressure and an inlet-side pressure at the inlet side results in the poppet being pushed upward to disengage from the first seat and translate to the open position.

14. The solenoid pilot valve of claim 1, wherein the solenoid pilot valve is configured to transition from a closed state to an open state in response to the coil assembly transitioning to an energized state.

15. The solenoid pilot valve of claim 14, further comprising a spring that, when the coil assembly transitions to a deenergized state, is configured to push the poppet from the open position to the closed position to sealingly engage the first seat of the valve body.

16. A solenoid pilot valve for cryogenic fluid, comprising:
a valve body including a first seat;
a poppet configured to translate between a closed position at which the poppet sealingly engages the first seat and an open position at which the poppet is disengaged from the first seat. wherein the poppet defines a pilot hole and includes a second seat adjacent the pilot hole,
a plunger assembly comprising:
a first plunger configured to translate between a first extended position and a Orst retracted position; and
a second plunger slidably coupled to the first plunger and extending toward the poppet, wherein the second plunger is configured to translate between a second extended position, a partially retracted position and a second retracted position, wherein the second plunger is configured to sealingly engage the second seat to close the pilot hole in the second extended position and is configured to be disengaged from the second seat to open the pilot hole in the partially retracted position and the second retracted position.

17. The solenoid pilot valve of claim 16, wherein the second plunger includes a ball that is configured to sealingly engage the second seat of the poppet when the second plunger is in the second extended position.

18. The solenoid pilot valve of claim 16, wherein the plunger assembly further includes a pin fixed to the second plunger, and wherein the first plunger defines vertical slots through which the pin slidably extends to enable the second plunger to slide relative to the first plunger

19. The solenoid pilot valve of claim 16. further comprising:
a first spring configured to bias the second plunger toward the second extended position and the poppet toward the closed position.
a second spring configured to further bias the second plunger toward the second extended position; and
a third spring configured to bias the first plunger toward the first extended position when the second plunger is in the second extended position.

20. The solenoid pilot valve of claim 16, wherein:
when the solenoid pilot valve is in a closed state, the poppet is in the closed position, the first plunger is in the first extended position, and the second plunger is in the second extended position.
when the solenoid pilot valve is in an intermediate state, the poppet is in the closed position, the first plunger is in the first retracted position, and the second plunger is in the partially retracted position; and
when the solenoid pilot valve is in an open state, the poppet is in the open position, the first plunger is in the first retracted position, and the second plunger is in the second retracted position.
